(19) United States
(12) Patent Application Publication
(10) Pub. No.: US 2019/0311616 A1
(43) Pub. Date: Oct. 10, 2019

(54) CONNECTED AND AUTOMATED VEHICLE SYSTEMS AND METHODS FOR THE ENTIRE ROADWAY NETWORK

(71) Applicant: CAVH LLC, FITCHBURG, WI (US)

(72) Inventors: Jing Jin, Basking Ridge, NJ (US); Bin Ran, Fitchburg, WI (US); Zhen Zhang, Madison, WI (US); Xiaowen Jiang, Madison, WI (US); Tianyi Chen, Madison, WI (US); Zhenxing Yao, Fitchburg, WI (US)

(21) Appl. No.: 16/379,291

(22) Filed: Apr. 9, 2019

Related U.S. Application Data
(60) Provisional application No. 62/655,651, filed on Apr. 10, 2018.

(51) Int. Cl. G08G 1/01; G08G 1/00; G08G 1/0967; G05D 1/02

(52) U.S. Cl. CPC G08G 1/0145; G08G 1/0112; G08G 1/0116; G05D 1/0285; G08G 1/22; G08G 1/096775; G05D 1/0297; G08G 1/0125

(57) ABSTRACT

This invention describes the detailed implementation of a Connected Automated Vehicle Highway (CAVH) on all roadway types. As CAVH vehicles travel within a transportation network, they will pass through different types of facilities such as basic segment, freeway or arterial segment, traffic bottlenecks, weaving and merging segment, intersections, first- and last-mile segment, parking, bridges, tunnel, multi-modal terminals and etc. Those different segments and nodes within a transportation network sometimes have drastically different geometric, design, and infrastructure characteristics. In this invention, detailed subsystem design will be described for each type of roadway segment for CAVH system to execute the entire trip door-to-door.

This application claims priority to U.S. provisional patent application Ser. No. 62/655,651, filed Apr. 10, 2018, which is incorporated herein by reference in its entirety.

### FIELD

The present invention relates to connected and automated vehicle highway (CAVH) systems and methods that cover all road types within a transportation network.

More specifically, the systems and methods provide control systems and subsystems for different road types to collect real-time vehicle information and provide control and guidance signals to participating CAVH vehicles to execute automated driving through different road segments and nodes.

### BACKGROUND

Autonomous vehicles, vehicles that are capable of sensing their environment and navigating without or with reduced human input, are in development. At present, they are in experimental testing and not in widespread commercial use. Existing approaches require expensive and complicated on-board systems, making widespread implementation a substantial challenge.

Alternative systems and methods that address these problems are described in U.S. patent application Ser. No. 15/628,331, filed Jun. 20, 2017, and U.S. Provisional Patent Application Ser. No. 62/626,862, filed Feb. 6, 2018 and U.S. Provisional Patent Application Ser. No. 62/627,005, filed Feb. 6, 2018 the disclosures of which are herein incorporated by reference in their entireties (referred to herein as a CAVH system).

The invention provides systems and methods to collect critical road-segment specific information from environments and vehicles and send back control instructions to connected and autonomous vehicles used to traverse roadway segment or nodes.

### SUMMARY

The present invention relates to connected and automated vehicle highway (CAVH) systems and methods that cover all road types within a transportation network. More specifically, the systems and methods provide control systems and subsystems for different road types to collect real-time vehicle information and provide control and guidance signals to participating CAVH vehicles to execute automated driving through different road segments and nodes.

For example, in some embodiments, provided herein is a connected and automated vehicle highway (CAVH) system comprising sensing, communication, and control components connected through segments and nodes that manage an entire transportation system. In some embodiments, the vehicles managed within the CAVH system comprise CAVH vehicles and non-CAVH vehicles. In some embodiments, the CAVH vehicles and non-CAVH vehicles comprise manual vehicles, automated vehicles, and connected vehicles.

In some embodiments, the segments and nodes have overlapping sensing and control areas with neighboring segment and nodes to hand off CAVH vehicles between neighboring segments and nodes.

In some embodiments, the CAVH system comprises four control levels: a) vehicle; b) road side unit (RSU); c) traffic control unit (TCU); and d) traffic control center (TCC).

In some embodiments, the vehicle control level comprises vehicles having on on-board system or application to operate a vehicle dynamic system to achieve on-road coordinate commands from an RSU.

In some embodiments, the RSU level involves segments or nodes managed by an RSU responsible for the sensing and control of vehicles. In some embodiments, the sensing comprising information from LiDAR and/or radar sensors or employs computer vision or other related systems that are deployed to fully capture information in a segment or node. In some embodiments, the RSU, in response to the sensing, manages collision avoidance, routing execution, lane change coordination, and high-resolution guidance commands in terms of on-road coordinates for vehicles to execute their automated driving.

In some embodiments, the TCU level involves multiple RSUs manages by a TCU. In some embodiments, the TCU is responsible for updating a dynamic map of moving objects and coordinated control among RSUs for continuous automated driving. In some embodiments, multiple TCUs are connected through TCCs to cover a region or subnetwork.

In some embodiments, the TCC level comprises high-performance computing and cloud services responsible for managing overall routing plans and updating a dynamic map of congestion, incidents, inclement weather, and events with regional impact. In some embodiments, the TCC level is further responsible for managing connecting with other application services including, but not limited to, payment and transaction systems, regional traffic management centers (TMCs), and third-party applications (e.g., government applications, private corporate applications, etc.). In some embodiments, multiple TCCs are employed to facilitate CAVH driving between or across large metropolitan areas.

In some embodiments, the sensing, communication, and control components comprise vehicle-level data and communication. In some embodiments, such data and communication comprise, for example, a vehicle layer comprising a vehicle-based on-board unit (OBU) layer that employs one or more or each of the following data flows: a) RSU identification and on-road guidance coordinates, wherein vehicles receive a security certificate and identification of the RSU in control and on-road guidance coordinates and other signals or notifications from the RSU in control; b) OBU sensor data comprising vehicle-based sensor data of surrounding vehicles and road conditions, wherein data is transmitted to an OBU controller to determine vehicle dynamic control signals and wherein part of the sensor data that impacts on other CAVH vehicles within the RSU is transmitted back to the RSU; and c) vehicle dynamic control signals (e.g., gas pedal actuator, brake actuator levels, and turning angles) are generated by an OBU controller, wherein information is transmitted with wired or wireless connection to a vehicle mechanical system.

In some embodiments, the sensing, communication, and control components comprise an RSU layer that employs one or more or each of the following data flows: a) a vehicle identification and routing plan wherein an RSU receives an identification and high-level routing plan and coordinates signals from a TCU; b) high-resolution sensor data of moving objects and infrastructure states within the RSU coverage area are processed internally, said sensor data comprising data that may impact decision-making of an OBU controller (e.g., speed limit, traffic control device states, vehicle conflict information, weather, and road surface conditions); wherein the sensor data is transmitted to a vehicle layer and wherein sensor data that may have impact on CAVH control of a local or regional network is transmitted through wired or wireless connection to a TCU; c) the RSU uses a real-time site map within a coverage area and a route execution plan of participating CAVH vehicles to generate high-resolution on-road guidance coordinates for each CAVH vehicle, wherein the guidance coordinates are transmitted to individual CAVH vehicles by wireless communication; and d) the RSU sends and receives vehicle handoff data in terms of vehicle identification, routing, and on-road guidance coordinates data to and from neighboring RSUs. In some embodiments, the high-resolution on-road guidance coordinates are broadcast to all CAVH vehicles or sent through a secured dedicated communication with individual vehicles.

In some embodiments, the sensing, communication, and control components comprise a TCU layer that employs one or more or each of the following data flows: a) CAVH vehicle identification, routing plan, and regional incidents and event alert data are received from TCCs; b) TCUs coordinate movements among RSUs in terms of pre-routing for mandatory lane changes and compliance with mandatory lane regulations, or pre-merging due to congestion; wherein vehicle-specific coordination signals are transmitted to RSUs; c) TCUs receive sensing data from RSUs that may impact multiple CAVH roadway segments and nodes; and d) TCUs send and receive vehicle handoff data in terms of vehicle identification and routing data to and from neighboring TCUs.

In some embodiments, the sensing, communication, and control components comprise a TCC layer that employs one or more or each of the following data flows for executing regional routing, updating regional event map, coordinating among TCUs and connecting with other applications and services: a) data exchange with transaction, payment, transit, and third party applications; b) signals comprising congestion mitigation information and active traffic management signals activated at regional or corridor levels are sent to individual TCUs; c) data exchange with regional traffic management centers regarding congestion, incidents, constructions, special events, and others traffic management information; and d) CAVH vehicle identification and high-level origin-destination and routing plan of participating vehicles.

In some embodiments, the sensing, communication, and control components manage system access and egress. In some embodiments, CAVH vehicles are collected from key entry nodes including, but not limited to, parking lots, side streets, ramps, and intersections. In some embodiments, upon entering the system, vehicle identification and origin-destination information is collected and transferred throughout a CAVH roadway system. In some embodiments, upon exiting the system, control of CAVH vehicles is returned to drivers. In some embodiments, if drivers are not immediately available, vehicles are parked at a storage/buffer location. In some embodiments, if an existing node is an automated parking location, vehicles will exit the CAVH control system upon fully parked at destinations.

In some embodiments, the system comprises a basic segment subsystem, comprising one or more or each of the components: a) a basic segment and infrastructure; b) basic services; c) basic management; d) a vehicle and onboard subsystem; e) a roadside sensing and command subsystem; f) local and regional traffic control (TCU/TCC); g) communication; h) cloud; and i) analytical, optimization, computing, and security centers.

In some embodiments, the basic segment and infrastructure component provides supporting functions to other modules, generates a high density (HD) map, provides HD positioning ability, and handles a switching function based on coverage information of different module segments.

In some embodiments, the vehicle and onboard system component controls and coordinates vehicles in CAVH system with the help of following modules: a) an interface module for communication between the vehicle and a human user; b) a communication module that transmits and receives vehicle control signals and traffic data to and from an RSU; c) a sensing module that, using sensors installed on vehicles, collects surrounding information and uses the information for driving decision making and sends selected information to an RSU using the communication module; d) an identification and security module that provides a vehicle's unique information to the system for tracking and security purposes; e) a bi-level driving signal combination modules that combines information from an RSU and from a vehicle's sensing module and divides the information into a high-level signal group and a low-level signal group; and f) an operation module that makes decisions about vehicle routing and operates the system based on a fused driving signal from other modules. In some embodiments, the high-level signals include but are not limited to, lane choice, approach, route, and vehicle relative positions. In some embodiments, the low-level signals include, but are not limited to, global position and current vehicle state.

In some embodiments, the roadside sensing and command subsystem component senses a roadside environment and controls or coordinates vehicles in CAVH system employing the one or more or each of the following components: a) a sensing component that collects environmental information; b) a communication component that transmits and receives vehicle control signals and traffic data to and from a vehicle and exchanges information with an upstream TCU; and c) a control and coordination component wherein an RSU receives feedback about control and coordination commands from a TCU and passes the commands to a vehicle subsystem. In some embodiments, the sensing component comprises information from LiDAR or radar sensors (or other sensor) and from computer vision (or other formats or sources).

In some embodiments, the local and regional traffic control (TCU/TCC) component optimizes and controls vehicles in a CAVH system based on three levels: a) low-level (T2V) including, but not limited to, driving queue management, entering/exiting, and transition; b) mid-level including, but not limited to, load balancing and event alerts; and c) high-level (TMC) including, but not limited to, congestion detection, alert, and mitigation.

In some embodiments, the cloud and CAVH service provision component provides services including, but not limited to, mobility provision services, data services, application services, and interaction with other urban services and applications. In some embodiments, the mobility provision services allow the CAVH system to work with other mobility provision services to improve performance. In some embodiments, the other mobility provision services provide their data and information to a CAVH cloud and receive aggregated feedback information. In some embodiments, the data services help the CAVH system store data and provide an ability to process and fuse data online and offline. In some embodiments, the application services provide interfaces to other services outside of the CAVH system. In some embodiments, the interfaces include well organized and designed information for specific demands, such as park-and ride, transit transition, event and activity, and POI (points of interest) information at the destination. In some embodiments, the interaction with other urban services/applications services interacts with government agencies and commercial companies to retrieve data for robustness and accuracy.

In some embodiments, the analytic, optimization, computing, and security centers component hosts physical hardware and equipment required for providing CAVH services.

In some embodiments, the system comprises a bottleneck segment subsystem that addresses recurrent or non-recurrent traffic congestion with relatively low speed and high density vehicles to facilitate low speed car following, driver comfort, and energy efficiency, comprising one or more or each of the components: a) a vehicle and onboard component that operates a CAVH vehicle in congested driving mode instead of regular mode to reduce fuel consumptions and increase safety and driver comfort in a microscopic level with eco-driving/platooning algorithms; b) a roadside component that considers all traffic in a bottleneck segment and organizes CAVH vehicles to reduce shockwaves and stop-and-go waves in macroscopic/mesoscopic levels by speed harmonization and dynamic merge control; c) a TCC component that processes regional traffic control signals including, but not limited to, detouring, temporary lane regulation, and interaction with other segments' subsystem; d) a cloud component that, in a congested segment, uses personal data management including, but not limited to, destination change, detouring demand, appointment reschedule, emergency, and toll collection plan; e) a sensing component that, in a bottleneck segment, requires additional sensing methods for vehicles overlapping with one another in crowded traffic that leads to line of sight issues for traffic sensors; and f) a communication component that provides extra communication capacity and devices to solve signal loss and lag.

In some embodiments, the system comprises a merge, diverge, and weaving segment subsystem comprising multi-vehicle type control and mixed traffic control components. In some embodiments, the merge, diverge, and weaving segment subsystem provides coverage on freeways including, but not limited to, mainline links, on-ramps, and off-ramps. In some embodiments, the merge, diverge, and weaving segment subsystem manages three different types of vehicles: a) mainline thru-vehicles, b) on-ramp merging vehicles, and c) mainline diverging vehicles. In some embodiments, the merge, diverge, and weaving segment subsystem permits customized control or guidance signals to different mixes of participating vehicles equipped with or without different CAV technologies.

In some embodiments, a merge control system comprises three control targets: a) vehicle control includes, but is not limited to, vehicle identification, vehicle target link/lane (thru, merge, diverge, thru inner lane), vehicle trajectory detection and transmission, merge control signal delivery, and human-machine interface; b) RSU control includes, but is not limited to, a dynamic map of merging and participating vehicles, vehicle data management, optimal gap and lane changing control, vehicle data feedback, and vehicle-based control guidance signal generation; and c) TCC control includes, but is not limited to, implementation of macroscopic merge control commands in response to macroscopic traffic conditions, including variable speed limits.

In some embodiments, the system comprises a first and last mile subsystem that manages trip start/end driving including, but not limited to, vehicle access/egress, driving navigation, human-machine interaction, and transition alerting and parking. In some embodiments, the first and last mile subsystem comprises an access subsystem and an egress subsystem. In some embodiments, the access subsystem manages and supports vehicles entering a CAVH roadway system from key nodes such as parking lots, side streets, ramps, intersections, and storage/buffer locations. In some embodiments, vehicle identification and origin-destination information is collected and transferred throughout the CAVH roadway system, comprising: a) an OBU for the access system has additional functions including, but not limited to, human-machine interaction, starting alerting, first mile navigation, and transfer-compliant driving; b) an RSU for the access system, among other functions, identifies accessing vehicles, collects accessing information, and charges a parking fee; c) TCU and TCC for the access system, among other functions, deals with accessing data from the RSU and accomplishes management functions including, but not limited to, approaching, routing, and vehicle movement; and d) cloud for the access system contains functions including, but not limited to, multi-modal/transferring, schedule protection, and other applications such as meeting/traveling. In some embodiments, the egress subsystem manages vehicles exiting a CAVH roadway safely. In some embodiments, when a vehicle approaches a border of a CAVH system, an alert is sent to drivers to select destination parking lots, and control of CAVH vehicles is returned back to drivers. In some embodiments, if drivers are not immediately available, vehicles are parked at a storage or buffer location. In some embodiments, if an exiting node is an automated parking location, vehicles exit the CAVH control system upon fully parked at destinations. In some embodiments, a) an OBU for the egress/dismiss system has additional functions including, but not limited to, human-machine interaction, ending alerting, automated parking, and transfer-compliant driving; b) an RSU for the dismiss system, among other functions, identifies dismissing vehicles, collects dismissing information, and provides parking sensing information including availability, and restrictions; c) TCU and TCC for the dismiss system, among other functions, deals with accessing data from the RSU, and accomplish management functions including, but not limited to, approaching, routing, and vehicle movement; and d) cloud for the dismiss system, among other functions, gives point-of-interest (POI) recommendations and parking information.

In some embodiments, the system comprises a buffer subsystem that manages parking and traveling when drivers make no response to border-approaching warnings at a CAVH boundary region. In some embodiments, the buffer subsystem comprises management of buffer parking, temporary parking within CAVH coverage, and buffer loop on-road and shoulder parking. In some embodiments, the buffer parking system automatically selects a buffer parking lot near a destination and executes parking when there is non-response from a driver during an egress process. In some embodiments, the buffer parking lot is located at a boundary area of the CAVH system. In some embodiments, when there is no buffer parking lot available near a selected destination, the buffer subsystem selects a temporary parking lot within the CAVH system near a destination to park the vehicle, waiting for the driver to take over control. In some embodiments, when the buffer parking lot and temporary parking lot both are not available near an egress node, the buffer system plans a buffer loop and controls a CAV vehicle on a CAVH road until the driver takes control the vehicle. In some embodiments, in areas where traffic is not busy, or under emergency situations, CAVs are permitted to park on a road shoulder.

In some embodiments, the system comprises an intersection subsystem that manages intersection nodes, OBUs, RSUs, TCU/TCCs, intersection services, and traffic management at intersections. In some embodiments, the intersection nodes have space management and reservation to handle traffic interaction.

In some embodiments, a mixed controller for coordinated control among CAVH vehicles and other manual, connected, and non-CAVH automated vehicles is another element involved in an intersection segment. In some embodiments, this uses the data collection and information feedback regarding the states of other interacting non-CAVH vehicles.

In some embodiments, a) an OBU contains vehicle dynamic control and intersection approach/departure applications in an intersection segment; b) an RSU provides vehicle lane group control and vehicle driving reservation and planning to help CAVs cross the intersection; c) TCUs/TCCs deal with approach management, RSU control, and vehicle movement management; and d) a computing and management center manages signal timing plan, lane and route management, and tracking and predicting of CAVH and non-CAVH vehicle movement and interactions. In some embodiments, the intersection service manages vehicle grouping, lane and route execution, and pedestrian and bicycle interaction.

In some embodiments, the system comprises a bridge, tunnel, and toll plaza subsystem that manages route planning, pre-merging control, and special lane navigation and control. In some embodiments, the special lane is a high-occupancy toll lane (HOT), high-occupancy vehicle lane (HOV), or reversible lane. In some embodiments, the bridge, tunnel, and toll plaza subsystem plans routes for vehicles once they enter a covered area per their: a) destination, said destinations including, but not limited to, thru-traffic, going off-ramp, need to be weighed, and entering dedicated lane; and b) vehicle type, said vehicle type including, but not limited to, high-occupancy vehicle, priority vehicle, and vehicle with e-toll tag. Meanwhile, the planned route will lead to pre-merging for some vehicles to reduce possible lane-changing delay in the area. In some special condition (e.g., heavy congestion, incident, maintenance, etc.), vehicles whose destination and type indicate a possible detour are routed to avoid the bridge/tunnel/toll plaza. In some embodiments, a) a vehicle level manages pre-merging control signals to prepare vehicles while approaching the bridge, tunnels, or toll plaza infrastructures; b) an RSU level maintains a real-time map of participating and surrounding vehicles and generates and distributes pre-merging plans; c) a TCU level communicates with nearby control units to adjust traffic light signals and other control objectives to coordinate entrance/exit traffic and achieve a system-wide optimization; and d) a TCC level receives event signals including, but not limited to, heavy congestion, incidents, maintenance, and extreme weather and influences control of the subsystem. The access to the covered area may be limited, and detour control information is broadcast.

In some embodiments, for special lane navigation and control, a) the CAVH system determines vehicle ID and whether or not the vehicle type is eligible for special lanes; b) vehicle platoon management is provided to facilitate cooperative car-following control and enable vehicle-platoon formation; c) RSUs manage vehicle platoon formation, deformation, and inserting and leaving events; and d) TCCs/TCUs process event information signals to provide warnings and guidance signals. In some embodiments, a determination of special lane eligibility considers occupancy levels for a HOV lane, electronic toll tag availability for a HOT lane, and routing plans for a reversible lane.

In some embodiments, the system comprises a parking subsystem that manages CAV parking processes for making vehicle access and egress the CAVH system safe and efficient. In some embodiments, the parking subsystem comprises three subsystems: a before trip system, a during trip system, and an after trip system. In some embodiments, the before trip system comprises a human-machine interface that allows drivers to make driving requests, and selects trip origin/destination (OD). In some embodiments, TCUs and TCCs compute requests and give commandments to parking lot RSUs and the parking lot RSUs execute a parking lot exit control and give travel route guidance to the vehicle. In some embodiments, the during trip system executes travel route and travel under the control of the whole CAVH roadway system and when vehicles approach a destination, an alert is sent by an RSU to a human-machine interface onboard a vehicle to select destination parking plans. In some embodiments, if the selected parking destination is beyond the CAVH system, a first and last mile system take over controls. In some embodiments, if a parking destination is within a CAVH area, vehicles exit the CAVH system upon fully parked at selected parking lots. In some embodiments, if drivers are not immediately available to make parking decisions, vehicles are parked at a storage or buffer location. In some embodiments, the after trip system executes parking charging and controls vehicle restarting and rerouting.

In some embodiments, the system comprises a multi-modal terminals component that provides I2X and V2X integration with other segments and nodes. In some embodiments, the component comprises a multi-modal terminal segment having modes information including, but not limited to, types, schedules, capacity, and routes, and provides park and ride options, pickup and drop-off locations, and gate and waiting areas. In some embodiments, the component comprises a vehicle and onboard system that comprising functions of navigation or self-driving vehicles within a terminal, guided or automated parking at terminal parking; multimodal notification, schedule selection, adhesion; and can auto navigate to a next trip. In some embodiments, the component comprises a roadside sensing unit that provides within-terminal facility traffic sensing system, parking sensing, and auto parking guidance. In some embodiments, the component comprises local and regional traffic control, wherein TCUs/TCCs that manage intersections deal with terminal approaching and departure management, in-terminal RSU control, and an ICM (integrated corridor management) application. In some embodiments, the component comprises a cloud component that provides multi-model planning, mode transferring and ticketing, parking space reservation, and fare payment system. In some embodiments, the component comprises a multi-modal services component that manages multi-modal trips, parking planning, and operations. In some embodiments, the component comprises a management center that manages multi-modal optimization and computing, inter-system coordination, pickup and drop-off optimization, and vehicle relocation optimization.

The systems and methods may include and be integrated with functions and components described in U.S. patent application Ser. No. 15/628,331, filed Jun. 20, 2017, and U.S. Provisional Patent Application Ser. No. 62/626,862, filed Feb. 6, 2018 and U.S. Provisional Patent Application Ser. No. 62/627,005, filed Feb. 6, 2018, the disclosures of which are herein incorporated by reference in their entireties.

Also provided herein are methods employing any of the systems described herein for the management of one or more aspects of traffic control. The methods include those processes undertaken by individual participants in the system (e.g., drivers, public or private local, regional, or national transportation facilitators, government agencies, etc.) as well as collective activities of one or more participants working in coordination or independently from each other.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Certain steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

### DRAWINGS

FIG. 1 shows an exemplary basic roadway segment.

FIG. 2 shows an exemplary subsystem of a bottleneck segment.

FIG. 3 shows an exemplary subsystem of a merge/diverge segment.

FIG. 4 shows an exemplary subsystem of a first and last mile segment.

FIG. 5 shows an exemplary subsystem of a buffer parking segment.

FIG. 6 shows an exemplary subsystem of an intersection segment.

FIG. 7 shows an exemplary subsystem of a bridge/tunnel/toll-plaza segment.

FIG. 8 shows an exemplary subsystem of a multi-terminal segment.

### DETAILED DESCRIPTION

Exemplary embodiments of the technology are described below. It should be understood that these are illustrative embodiments and that the invention is not limited to these particular embodiments.

The following words, phrases, numbering, and abbreviations are used in the exemplary embodiments described below (arranged, for convenience, in order corresponding to the order of the figures).

Basic Segment:

101—OBU: On-board Units, that control and coordinate vehicles in a CAVH system with the help of interface, communication, sensing, identification/security, driving signal combination, and operation modules;

102—OBU Sensors: installed on vehicle, collecting surrounding information, and using the information for multiple tasks;

103—Local Dynamic Map: surrounding modeling based on the data from sensors on vehicle and map data received from a Road Side Unit (RSU);

104—Planning and Decision Making: instructions from RSU. For emergency situation, vehicles will make immediate decisions by themselves;

105—RSU: Roadside Units, that receive data flow from connected vehicles, detect traffic conditions, and send targeted instructions to vehicles. The RSU network focuses on data sensing, data processing, and control signal delivery. Physically, e.g. a point traffic control unit (TCU) or segment traffic control center (TCC) can be combined or integrated with a RSU;

106—RSU Sensors: installed on RSUs, collecting surrounding information, such as road geometry data, lane information, vehicle identification data, and movement related data, and using them for multiple tasks;

107—Local Server: local processing and storage center, that generates a dynamic map and calculates CAVH control/guidance signals based on the sensor data;

108—Dynamic Map: dynamic information about the surroundings;

109—Static Map: predefined map information based on offline data such as mobile LiDAR data, that will be updated periodically;

110—Communication between RSU and OBU: data flow including instructions from RSU to OBU and sensor data from OBU to RSU;

111—Communication between RSU and CAVH Cloud: data flow, including raw data uploading to Cloud and processed data back to RSU;

112—TCU: Traffic Control Unit, covering a small freeway area, ramp metering, or intersections that focus on data gathering, traffic signals control, and vehicle requests processing;

113—Low-level (T2V): Low-level traffic control, including driving queue management, entering/exiting, transition, etc.;

114—Mid-level (T2T): Mid-level traffic control, including load balancing, event alerts, etc.;

115—High-level (TMC): High-level traffic control, including congestion detection/alert/mitigation, etc.;

116—Communication between TCU and RSU: data flow including instructions from TCU to RSU and necessary data from RSU to TCU;

117—Communication between TCU and CAVH Cloud: data flow including raw data uploading to Cloud and processed data back to TCU;

118—CAVH Cloud: platform providing several services, including mobility provision services, data services, application services, and interaction with other urban services/applications;

119—Mobility Provision Service: system interfaces from other mobility providers;

120—Data Services: a subsystem helps CAVH system storage massive amount of data and provides the ability to process and fuse them online and offline;

121—Application Services: a subsystem that publishes and communicates processed information for the entire CAVH system;

122—Interaction with Other Services: a subsystem that can offer mature interfaces to other services outside of the CAVH system. These interfaces include well organized and designed information for specific demand; a subsystem interacts with other related services provided by public and private providers to retrieve or exchange data for integrated services and applications;

123—Other Cloud Services: other systems including related public and private transportation or other service providers;

Bottleneck Segment:

201—RSU Sensor: Including RTMS, LiDAR, High-angle camera, etc. Detect the information of traffic and send it to an RSU controller.

202—Additional temporary RSU Sensor for bottleneck segment: Crowded traffic requires additional sensors to detect the vehicles that are overlapped by others, including mobile LiDAR, UAV, etc.

203—RSU Communication: Comprise wireless communication such as 4G-LTE and GSM, and local communication such as Ethernet, DSRC, etc. Redundant RSU communication is deployed in this segment for high network volume with crowded users.

204—RSU Controller: Processes the data transmitted in communication network, generates control signal, and sends it to users.

205—CAVH Eco-Driving Single Vehicle OBU: CAVH vehicle with eco-driving function enabled. Eco-driving function allows CAVH vehicles to drive with reduced fuel consumptions and increased safety as well as comfortability in microscopic level. Vehicles in this category do not group up as a platoon.

206—CAVH Eco-Driving Platoon Vehicle OBU: CAVH vehicle with eco-driving function enabled that is also grouped with the preceding and following CAVH eco-driving vehicles as an eco-platoon. Eco-platoon coordinates the members with coordinated eco-driving algorithms to reduce total fuel consumption and increase safety in crowded traffic environment.

207—Non-CAVH vehicle: Vehicles that are not participating in a CAVH system, but still can be sensed by RSU sensors.

208—Cloud Services: Personal cloud data management such as destination change, detouring demand, appointment reschedule, emergency, toll collection plan, etc.

209—TCC Services: Processes the regional traffic control signal including detouring, temporary lane regulation, and interaction with the other segments' subsystem, etc.

210—CAVH Platoon Functionalized Cut-in: A CAVH platoon is cut-in by another CAVH platoon. The platoon grows and grants the applied platoon function to the new joined CAVH vehicle.

211—CAVH Platoon Unfunctionalized Cut-in: A CAVH platoon is cut-in by a non-CAVH platoon. The platoon is split and forms two new platoons. The new establishment of inner coordination and control function for the two platoons starts over again.

212—CAVH V2I Link: Interaction Between RSU and CAVH Vehicle. RSU sensors detect the CAVH vehicles and communicate with them with feedback. Eco-driving algorithm is applied by RSU controller on a single CAVH vehicle and a control signal is transmitted via the V2I communication. Eco-driving platoon algorithms are applied by an RSU controller on CAVH platoon and a control signal is transmitted via the V2I communication chain/network.

213—V2I Communication Between RSU and CAVH Eco-Driving Single Vehicle.

214—Detection of CAVH Eco-Driving Single Vehicle.

215—V2I Communication Between RSU and CAVH Eco-Driving Platoon Vehicle.

216—Detection of Non-CAVH vehicles: Non-CAVH vehicles are detected by RSU sensors, and the profile data is transmitted to an RSU controller via the RSU communication. However, the feedback from vehicles and controllability is not available.

217—CAVH V2V Link: CAVH vehicles are able to detect the surrounding vehicles by the devices equipped onboard, such as onboard radar or LiDAR. The V2V communication is also available if surrounding vehicles are also CAVH vehicles. V2V communication is also used to enhance the eco-driving platoon control.

Merge/Diverge:

301—RSU: Comprises RSU sensor, RSU Communication, and RSU controller. It can detect vehicles and communicate with other units.

302—Vehicle/OBU: Comprise CAVH vehicles that communicate with RSUs and can be detected, and non-CAVH vehicles that cannot communicate with RSU, but still can be detected. CAVH vehicles can also detect their surrounding vehicles by onboard sensors as well as communicate with surrounding other CAVH vehicles.

303—TCC: TCC Control includes the implementation of a macroscopic merge control command in response to macroscopic traffic conditions, e.g. variable speed limit.

304—CAVH Cloud Services: CAVH cloud manages feedback of CAVH services including scheduling and routing.

305—Other Cloud Services: Other Cloud component manages feedback of other cloud services including POI recommendation, transit, etc.

306—CAVH V2I Link: CAVH vehicles can be detected by RSUs, and can also communicate with RSUs to send feedback and receive control command.

307—non-CAVH V2I Link: Non-CAVH vehicles can be detected by RSUs, but it cannot communicate with RSUs.

308—Full CAVH V2V Link: CAVH vehicles can detect surrounding CAVH vehicles by onboard sensors, and can also communicate with other surrounding CAVH vehicles by onboard communication devices.

309—Partial CAVH V2V Link: CAVH vehicles can detect its surrounding non-CAVH vehicles by onboard sensors. Some non-CAVH vehicles may also be able to detect their surrounding if stock sensors are equipped, while others are not able to detect surroundings if no sensors are equipped. However, the communication between CAVH vehicle and non-CAVH vehicle is unavailable.

310—Merge/diverge scenario I

311—Merge/diverge scenario II

312—Merge/diverge scenario III

313—Merge/diverge scenario IV

First and Last Mile:

401—Road Link-Node System: The whole CAVH systems in the road network areas, that controls the CAVs traveling on different types of urban roads.

402—Vehicle OBU: On-board units, that controls and coordinates vehicle in a CAVH system with the help of interface, communication, sensing, identification/security, driving signal combination, and operation modules;

403—Link-Node RSU: Roadside Units, that receive data flow from connected vehicles, detect traffic conditions, and send targeted instructions to vehicles. The RSU network focuses on data sensing, data processing, and control signal delivery. Physically, e.g. a point TCU or segment TCC, can be combined or integrated with a RSU;

404—Link-Node TCU, TCC: Traffic Control Unit, covering a small freeway area, ramp metering, or intersections that focus on data gathering, traffic signals control, vehicle requests processing, and travel routing. TCU systems are the subsystem of TCC.

405—Merge/Diverge System: Decision making units for CAVs to merge into/diverge from the traffic flow safely and efficiently.

406—Communication from Road Link-Node System to Boundary Detection & Control handover system: Egress data flow including CAV travel plan, approaching situation and vehicle locations for CAVH Boundary Detection & Control handover system to operation.

407—Boundary Detection & Control handover system: Sensing units installed on the boundary of a CAVH system that detects the approaching position of vehicles and sends messages to drivers to take control of the vehicle if necessary. It also makes buffer parking plans when no reply is received from the driver.

408—Communication from Boundary Detection & Control handover system to Road Link-Node System: Access data flow, including vehicle travel plan, approaching situation and locations from the CAVH Boundary Detection & Control handover system to Road Link-Node System.

409—Communication from Boundary Detection & Control handover system to Buffer Parking System: data flow about buffer parking plans for buffer parking system to reserve service.

410—CAVH User Interface: User devices including cellphone applications, portable devices, and Internet to call for driving/parking service.

411—Communication between CAVH User Interface and TCU: data flow about CAV service application from CAVH User Interface to TCU. The communication uses, for example, a 4G/5G wireless network.

412—TCU: Traffic Control Unit, covering a small freeway area, ramp metering, or intersections that focuses on data gathering, traffic signals control, and vehicle requests processing;

413—Communication between TCU and TCC: data flow about driving and parking information from TCU to TCC.

414—TCC: Traffic Control Unit, that makes travel decision and travel routing.

415—Communication between TCC and Parking/Driving Control Units: data flow including parking/travelling plans from the TCC to Parking/Driving Control Units.

416—Communication between TCC and Parking Lot information System: data flow information for TCC to make parking plans and for parking lots to reserve parking services.

417—Local Street Navigation System: Navigation units, that support vehicle navigation outside the CAVH road network.

418—Communication between Local Street Navigation System and TCC: data flow for TCC to plan travel routes and for Local Street Navigation System to guide the travel.

419—Parking/Driving Control Units: Roadside units to control vehicle parking and driving.

420—Communication between Parking/Driving Control Units and Parking system: data flow including vehicle parking lot selection and vehicle positions.

421—Parking Lot information System: Roadside units, that collect parking lot information.

422—Communication between Parking Lot information System and Parking System: data flow about parking lot status, open/closed and available/full.

423—Parking system: Parking facilities and service including different kinds of parking lots and automatic parking services.

424—Buffer Parking: Parking facilities and services including buffer parking, buffer loop, and shoulder parking.

425—Terminal Parking: Parking facilities and service for vehicle parking and transferring at transportation terminal.

426—Home Parking: Parking facilities and service for vehicle parking at home.

427—Street Parking: Parking facilities and service for vehicle parking on street.

428—Garage Parking: Parking facilities and service for vehicle parking at a garage.

429—Surface Parking: Parking facilities and service for vehicle parking on a field surface.

430—Valet Parking: Parking facilities and services for vehicle parking by valet.

431—Cloud: Storage of massive amounts of data and provides the ability to process and fuse data online and offline.

Buffer Parking

501—Buffer Parking: A kind of emergency parking strategy. For safety, the CAVH system guides vehicles to a buffer parking lot when the vehicle plans to drive outside the system and no driver takes control of the vehicle in time.

502—Buffer Loop: CAV driving control strategy. Under the background of buffer parking, if no buffer parking lot is available, the CAVH system guides vehicles to keep driving on the roads.

503—Temporary Parking: A kind of parking strategy. Under the background of buffer parking, if no buffer parking lot is available and the road traffic condition is not good (or drives too long a time on the loop), the CAVH system guides the vehicles to a nearest in-system parking lot for temporary parking.

504—Shoulder parking: A kind of emergency parking strategy. In some special condition, such as the rural road, when the road shoulder area is enough for buffer parking, then the vehicles need not drive to a dedicate buffer parking lot, but just park on the road shoulder.

505—RSU: Roadside Units, that receive data flow from connected vehicles, detect traffic conditions, and send targeted instructions to vehicles. The RSU network focuses on data sensing, data processing, and control signal delivery.

506—Communication between TCU and RSU: data flow including instructions from TCU to RSU and necessary data from RSU to TCU;

507—TCU: Traffic Control Unit, covering a small freeway area, ramp metering, or intersections that focus on data gathering, traffic signals control, and vehicle requests processing;

508—Communication between TCU and TCC: data flow about driving and parking information from TCU to TCC.

509—TCC: Traffic Control Unit, that makes travel decision and travel routing.

510—Parking Sensor: Roadside units, that help automatic parking.

511—Shoulder Detector: Roadside units, that detect the condition of road shoulders and make shoulder parking decision.

Intersection:

601—OBU: On-board Units, that contain intersection approach/departure applications;

602—RSU: Roadside Units, that provide vehicle lane group control and vehicle reservation;

603—TCU: Traffic Control Unit, covering intersections that focus on data gathering, traffic signals control, and vehicle requests processing;

604—TOC/TCC: Traffic operation center and traffic control center, covering regional and larger area traffic management;

605—CAVH Cloud: platform providing several services, including mobility provision services, data services, application services, and interaction with other urban services/applications;

606—CAVH intersection platoon: groups of vehicles with similar approaching/turning movement, the system allows non-CAVH vehicles to join the movement;

607—Reservation/Preparation: one of the intersection CAVH control stages where vehicles preparing enter the intersection;

608—Intersection Movement: one of the intersection CAVH control stages where vehicles passing through the intersection;

609—Departure and Exiting: one of the intersection CAVH control stages where vehicles exiting the intersection;

610—Communication from RSU to OBU or other device: data flow including CAVH control/guidance signals from RSU to OBU;

611—Communication between RSUs: data flow including control/guidance signals from one RSU to other RSUs;

612—Communication from OBU to RSU: data flow including control/guidance signals from OBU to RSU;

613—Communication between TCU/TCC/CAVH Cloud and RSU: data flow including control/guidance signals from TCU/TCC/CAVH Cloud to RSU and necessary data from RSU to TCU;

614—Confliction between non-CAVH vehicles and CAVH vehicles;

615—RSU sensors: detect vehicles in different stage/movement in the intersection.

Bridge/Tunnel/Toll-Plaza

701—RSU: Comprise RSU sensor, RSU Communication, and RSU controller. It can detect vehicles and communicate with other units.

702—Vehicle/OBU: Comprise CAVH vehicles that can communicate with an RSU and can be detected, CAVH vehicles with lane priority, and non-CAVH vehicles that cannot communicate with an RSU but still can be detected. CAVH vehicles can also detect their surrounding vehicles by onboard sensors as well as communicate with surrounding other CAVH vehicles.

703—CAVH Vehicle Platoon: A platoon of CAVH vehicles with platoon control activated.

704—TCC: TTC can receive event signals including heavy congestion, incidents, maintenance, extreme weather, etc. and influence the control of this subsystem. The access to the covered area may be limited, and detour control information is broadcasted.

705—TCU: The control unit in this subsystem can communicate with nearby control units to adjust the traffic light signal and other control objectives to coordinate the entrance/exit traffic and achieve a system-wide optimization.

706—Lane Regulation: Lanes with special regulation such as toll lane, HOV lane, convertible lane, etc.

707—Additional RSU Sensor for Tunnel/Bridge Lower Deck: Special vehicle sensors, such as in-door CCTV video sensors and in-door positioning systems that are cost-effective for in-door deployment where GPS signal may be unavailable.

708—Additional RSU Communication for Tunnel/Bridge Lower Deck: The quality of wireless communication in a tunnel/lower deck is challenging. Thus, additional communication devices such as in-door microscopic communication units are used in this environment.

709—Pre-Routing Services for Different Deck/Tunnel in Approaching Stage: In approaching stage, CAVH vehicles are pre-routed to a different lane/path to get a smooth access to specific deck/tunnel/road according to their destination and preference.

710—Pre-Routing Services for Different Toll Method in Toll Plaza: CAVH vehicles with different toll-devices or toll-plan are pre-routed to a different lane/path before they reach a toll-gate to avoid congestion in a toll plaza.

711—Pre-Routing Services for Different Exit Direction in Departure Stage: CAVH vehicles are pre-routed to a different lane/path to get a smooth access to a specific exit ramp/link according to their destination and preference.

712—CAVH V2I Link: CAVH vehicle is detected by an RSU, and it also can communicate with an RSU to send feedback and receive control command.

713—non-CAVH V2I Link: Non-CAVH vehicle can be detected by an RSU, but it cannot communicate with an RSU.

714—CAVH V2I Link in Lower Deck/Tunnel: CAVH V2I link in this area is not guaranteed. Detection may be unavailable in some segments and V2I communication may have high packet-loss/delay.

715—non-CAVH V2I Link in Lower Deck/Tunnel: Detection for non-CAVH vehicles in this area may be unavailable in some segment.

716—Full CAVH V2V Link: CAVH vehicle can detect its surrounding CAVH vehicles by an onboard sensor, and it can also communicate with other surrounding CAVH vehicles by onboard communication devices. Several CAVH vehicles in a platoon can form a communication chain to enhance the RSU communication coverage and CAVH platoon control, especially in area with poor communication coverage, e.g. lower deck of bridge or tunnel.

717—Partial CAVH V2V Link: CAVH vehicle can detect its surrounding non-CAVH vehicles by an onboard sensor. Some of the non-CAVH vehicles may also be able to detect their surroundings if stock sensors are equipped, while others are not able to detect surroundings if no sensors are equipped. However, the communication between a CAVH vehicle and a non-CAVH vehicle is unavailable.

Multi-Terminal:

801—Parking lot RSU, road side unit that has parking sensing and auto parking guidance;

802—Local bus RSU, road side unit that has within-terminal facility traffic sensing system, transit schedule and planning;

803—Ticket center RSU, road side unit that has user interface (UI) with hand held units (HHU) for ticketing;

804—Long-range bus RSU, road side unit that has transit schedule and planning, waiting time arrangement, baggage allocation;

805—Subway RSU, road side unit that has UI with HHU for ticketing, model transfer;

806—TCU: Traffic Control Unit, covering multi-terminal region that focuses on terminal approaching. Departure routing and optimization;

807—TOC/TCC: Traffic operation center and traffic control center, covering regional and larger area traffic management;

808—CAVH Cloud: platform providing several services, including multi-modal planning, mode transferring and ticketing, parking space reservation, parking/fare payment system;

809—Communication between Parking lot RSUs and passenger car OBUs, data flow including instruction and sensor data;

810—Communication between local bus RSUs and HHUs, data flow including transit schedule;

811—Communication between local bus RSUs and bus OBUs, data flow including instruction and sensor data;

812—Communication between ticket center RSUs and ticket center server, data flow including ticket reservation;

813—Communication between ticket center RSUs and HHUs, data flow including ticketing information, transit schedule, parking information;

814—Communication between long-range bus OBUs and HHUs, data flow including transit schedule, baggage allocation information;

815—Communication between long range bus RSUs and bus OBUs, data flow including parking reservation, transit planning, waiting time arrangement;

816—Communication between subway RSUs and HHUs, data flow including subway schedule, ticketing;

817—Communication between subway RSU and subways, data flow including schedule, ticketing;

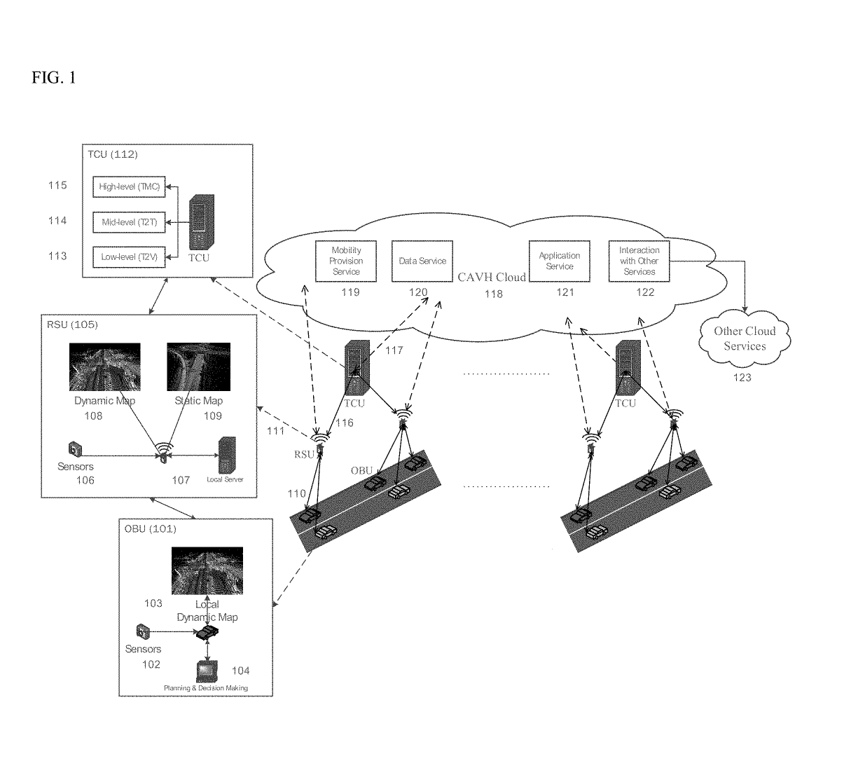

FIG. 1 shows a basic segment (BS) system residing in a CAVH system. Basically, the BS system contains the following components: CAVH cloud 118, TCU 112, RSU 105, and OBU 101. OBU retrieves the data collected by OBU Sensor 102, including surrounding information. OBU communicates 110 with RSU to exchange driving instruction, processed sensing data, etc. Based on all the data it receives, OBU generates an environment and collaborates with a local processor for final planning and decision making 104. RSU stores and updates static map 109 periodically, which is provided by map providers. RSU sensors 106 are also installed for collecting segment information. This information is processed and fused with a static map and a high definition (HD) map from map providers to generate a real-time dynamic map 108. RSUs communicate 116 with the nearest TCU and upload collected and fused data to the TCU for further computation-heavy fusion. Driving instructions are downloaded from the TCU and transmitted to target OBUs. In some embodiments, there are three levels of traffic control operated in TCUs: Low level (T2V) 113, Mid-level (T2T) 114, and High-level (TMC) 115: Low-level traffic control includes driving queue management, entering/exiting, transition, etc.; Mid-level traffic control includes load balancing, event alerts, etc.; High-level traffic control includes congestion detection/alert/mitigation, etc. The Data Service 120 receives to-be-processed data from a TCU and feeds it back after computation through communication channel 117. There are also Mobility Provision Service 119, Application Service, and Interface for Other Services 122 inside a CAVH Cloud. A CAVH system can work with other mobility provision services to achieve better performance in terms of a whole transportation system. Other mobility provision services provide their data and information to the CAVH cloud and can get the aggregated feedback information. Application Services can offer mature interfaces to other services outside the CAVH system. These interfaces include well organized and designed information for specific demand. This subsystem also interacts with other related government agencies and commercial companies to retrieve necessary or useful data for robustness and accuracy.

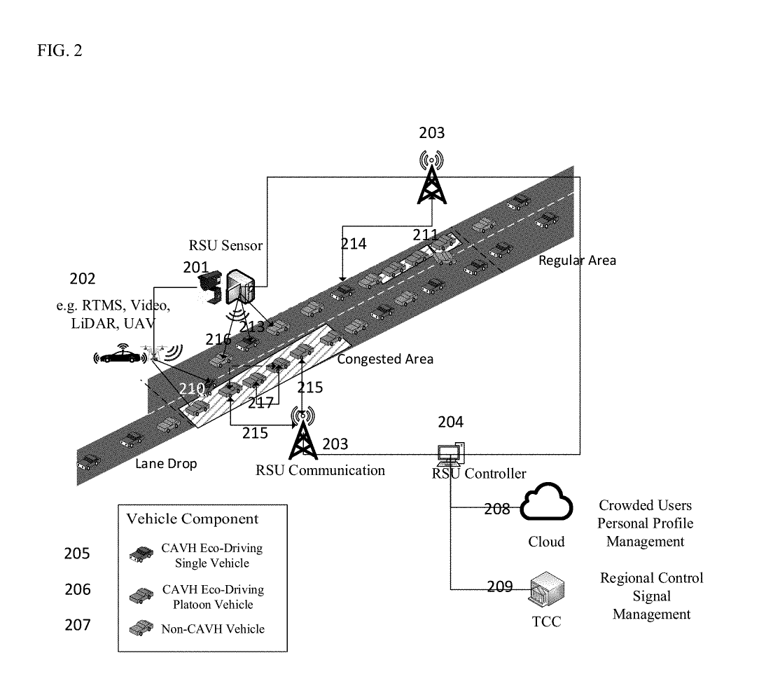

FIG. 2 shows a bottleneck segment system residing in a CAVH system that contains the following components: RSU 105, CAVH Vehicle/OBU 101, Cloud Services 208, and TCC 209. Additional temporary sensors 202 are deployed for this crowded environment. In some embodiments, a CAVH eco-driving algorithm is applied for a single CAVH vehicle allowing it to drive with reduced fuel consumptions and increased safety as well as comfortability. In some embodiments, a CAVH eco-driving platoon control is applied for a CAVH platoon to coordinate the members with a coordinated eco-driving algorithm to reduce total fuel consumption and increase safety in a crowded traffic environment. The CAVH eco-driving platoon may be cut-in by other vehicles. The functionalized cut-in 210 means that a CAVH platoon is cut-in by another CAVH platoon. The platoon grows and grants the applied platoon function to the new joined CAVH vehicles. The unfunctionalized cut-in 211 means a CAVH platoon is cut-in by a non-CAVH platoon. The platoon is split and forms two new platoons. The new establishment of inner coordination and control function for the two platoons starts over again. CAVH V2I Link 212 allows detection of CAVH vehicles (214) and communication with them (213/215). Non-CAVH vehicles can also be detected by RSU (216), although the communication is unavailable. CAVH V2V link 217 provides a supplementary detection/communication link to expand the system's detection and control ability.

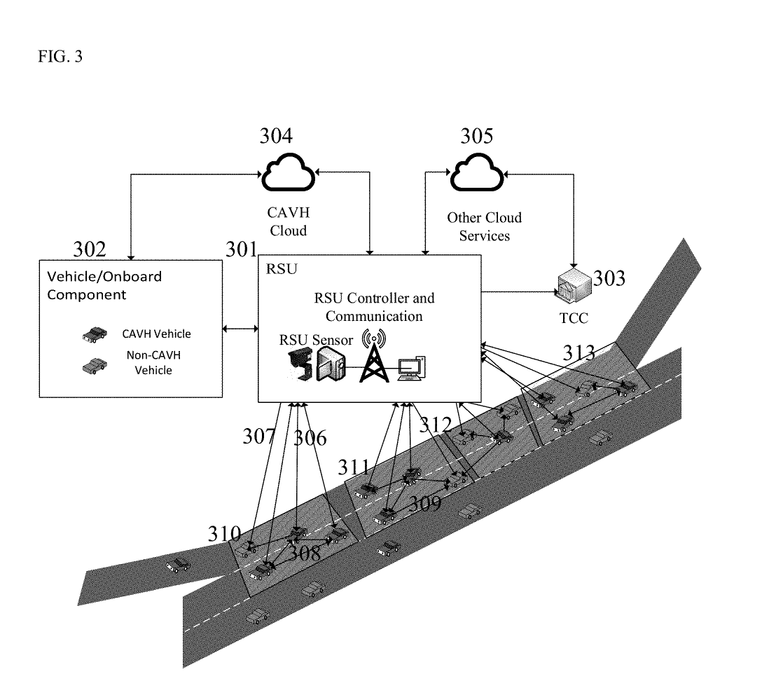

FIG. 3 shows a merge/diverge system residing in a CAVH system that contains the following components: RSU 301, CAVH Vehicle/OBU 302, TCC 303, CAVH cloud services 304, and other cloud services 305. A CAVH vehicle is detected by and can communicate with RSU 306 to send feedback and receive control command via V2I link 306. Non-CAVH vehicles can also be detected by the RSU via non-CAVH V2I Link 307, but cannot communicate with the RSU. Full CAVH V2V link 308 and partial CAVH V2V link 309 provides a supplementary detection/communication link to expand the system's detection and control ability. RSU also connects with CAVH cloud services and other cloud services for cloud services and feedback management. Four merging scenarios with different combinations of vehicle types involved in a merge/diverge activity are organized and controlled by the system. The covered combination is listed below:

| | Scenario I | | Scenario II | | Scenario III | | Scenario IV | |
|---|---|---|---|---|---|---|---|---|
| PL | CAVH | CAVH | CAVH | Non- | Non- | Non- | CAVH | Non- |
| | | | | CAVH | CAVH | CAVH | | CAVH |
| PF | CAVH | CAVH | Non- | CAVH | Non- | Non- | CAVH | CAVH |
| | | | CAVH | | CAVH | CAVH | | |
| R | CAVH | CAVH | CAVH | CAVH | CAVH | CAVH | Non- | Non- |
| | | | | | | | CAVH | CAVH |
| RL | CAVH | Non- | CAVH | CAVH | CAVH | Non- | CAVH | CAVH |
| | | CAVH | | | | CAVH | | |
| | Scenario I | | Scenario II | | Scenario III | | Scenario IV | |
| PL | | | CAVH | Non- | | | CAVH | Non- |
| | | | | CAVH | | | | CAVH |
| PF | | | Non- | CAVH | | | CAVH | CAVH |
| | | | CAVH | | | | | |
| R | | | CAVH | CAVH | | | Non- | Non- |
| | | | | | | | CAVH | CAVH |
| RL | | | Non- | Non- | | | Non- | Non- |
| | | | CAVH | CAVH | | | CAVH | CAVH |

| | Not Covered V | | Not Covered VI | |
|---|---|---|---|---|
| PL | Non- | Non- | CAVH | CAVH |
| | CAVH | CAVH | | |
| PF | Non- | Non- | Non- | Non- |
| | CAVH | CAVH | CAVH | CAVH |
| R | Non- | Non- | Non- | Non- |
| | CAVH | CAVH | CAVH | CAVH |
| RL | CAVH | Non- | CAVH | Non- |
| | | CAVH | | CAVH |

In these scenarios, Ramp Merge/Diverse (R), Putative Leading Vehicle (PL), and Putative Following Vehicle (PF) can be CAVH or non-CAVH vehicles that support different scales of controllability of the gap and vehicle. The leading vehicle of the ramp vehicle R (RL) can be either a CAVH vehicle or a non-CAVH vehicle. CAVH RL can participate in the assisted merge activity to enhance the mobility and safety, while the location of non-CAVH RL can just be a virtual spatial constraint of R to ensure its safety in the merging lane and the feasibility of control signals.

In Scenario I 310: Merge/Diverge Vehicle (R), Gap Leading Vehicle (PL), and Gap Following Vehicle (PF) are all CAVH vehicles. In this scenario, both the merge/diverge vehicle and gap can be detected by the RSU and can be fully controlled by system for a coordinated merge.

In Scenario II 311: R is a CAVH vehicle, but one of PL and PF is a CAVH while the other is a non-CAVH. In this scenario, if PF is CAVH and PL is non-CAVH, the gap is still considered as controllable; If PL is CAVH and PF is non-CAVH, the gap is considered as partially controllable, and the merge/diverge assistance algorithm is adjusted for this special case. The non-CAVH vehicle cannot communicate with system, but still can be detected by RSU sensors.

In Scenario III 312: R is CAVH vehicle, and both PL and PF are non-CAVH vehicles. In this scenario, the merge/diverge vehicle can be detected and controlled to be safely and efficiently filled into a mainline gap. The mainline gap is not controllable, but can still be detected by a RSU sensor. A passive merge/diverge assistance algorithm is applied in this scenario.

In Scenario IV 313: R is a non-CAVH vehicle, but the gap is controllable (PF is a CAVH vehicle, PL is a CAVH/non-CAVH vehicle). In this scenario, merge/diverge vehicles cannot be controlled but can still be sensed by system, and the system can adjust the gap's speed and location to help R merging.

Not Covered Scenario V: PL, PF and R are all non-CAVH vehicle, this merge/diverge activity is not covered by the CAVH system.

Not Covered Scenario VI: R and PF are non-CAVH vehicles, but PL is a CAVH vehicle. The gap can only be partially controlled while the merge/diverge vehicle is not controllable. The system does not cover this scenario because of lack of controllability.

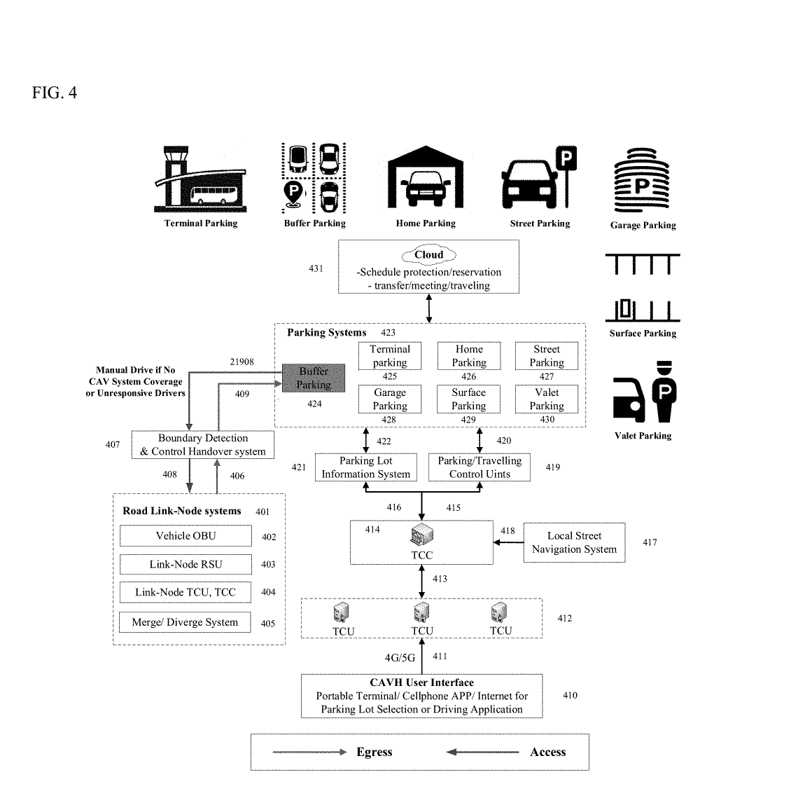

FIG. 4 shows a First and Last Mile System in a CAVH system. Basically, the First and Last Mile System deals with the egress and access process when CAVs approach the boundary of the CAVH system. Vehicle control strategy (automatic or manual), vehicle parking and system interaction are introduced. The First and Last Mile System contains the following components: Road Link-Node System 401, Boundary Detection and Control System 407, CAVH User Interface 410, TCU 412, TCC 414, Local Street Navigation System 417, Parking/Travel Control Units 419, Parking Lot Information System 421, Parking System 423 and Cloud 431. Road Link-Node System 401 controls the CAVs traveling and parking on different type of urban roads. It has the whole CAVH function and contains Vehicle OBU 402, Link-Node RSU 21103, Link-Node TCU, TCC 414 and Merge/Diverge System 405. When CAVs approach the boundary of the CAVH, the Boundary Detection and Control System 407 detects and gives messages to drivers to take over the control. If no reply is received from a driver, the system makes buffer parking plans and makes the vehicle parking at a buffer parking lot or continue travelling on the CAVH roads. CAVH User Interface 410 is used to apply driving services through a wireless communication network, such as a 4G/5G network. TCU 412 receives applications and transfers information to a TCC. TCC 414 deals with the data and makes parking/driving plans for drivers, considering data flow from Local Street Navigation System 417, Parking/Travel Control Units 419, and Parking Lot Information System 421. Parking/Traffic Control Units 419 controls the vehicle parking and travelling between parking lots and drivers. Parking Lot Information System 421 collects parking lot available status for parking decision making. Parking System 423 supports all kinds of parking facilities and parking service. Cloud 431 stores massive amount of data and provides the ability to process and fuse them online and offline. In some embodiments, it is a basic component of a CAVH system.

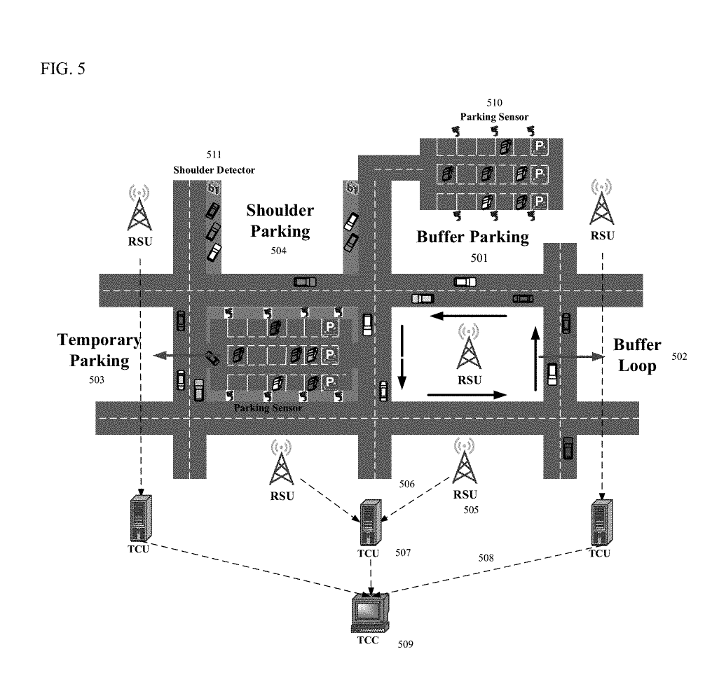

FIG. 5 shows a Buffer System in a CAVH system. Basically, the Buffer System is a sub-system of the First and Last Mile System that actives under four scenarios: 1. Human driver is not responsive for take-over signals; 2. Human driver is pre-occupied in other activities; 3. Vehicle control or communication error; and 4. Temporary parking (ahead of arriving schedule). The Buffer System contains the following components: Buffer Parking 501, Buffer Loop 502, Temporary Parking 503, Shoulder parking 504, RSU 505, TCU 507, TCC 509, Parking Sensor 510, Shoulder Detector 511, and Charging Stationl. Buffer Parking 501 guides the CAV to a buffer parking lot when the vehicle plans to drive outside of the system and no driver takes control of the vehicle in time. If no buffer parking lot is available near the destination, the CAVH system guides the vehicle to keep driving on the roads as Buffer Loop 501. If no buffer parking lot is available and the road traffic conditions are not good (or the vehicle drives for too long of a time on the loop), the CAVH system guides the vehicles to a nearest in-system parking lot for temporary parking 503. Shoulder parking 504 deals with special situation when the road shoulder is detected as sufficient for temporary parking. In such a situation, the vehicle need not drive to a distant parking lot. RSU 505 receives data flow from connected vehicles, detects traffic conditions, and sends targeted instructions to vehicles. Covering a small freeway mainline or ramp segments, merging or diverging segments, or arterial intersections, TCU 507 deals with real-time traffic data gathering, traffic signal control, vehicle request processing, and communication with the RSU. TCC 509 collects all the data and makes parking/driving plans for CAVs. When vehicles received parking/driving plans, Parking Sensor 510 helps to automate parking. Shoulder Detector 511 detects the road shoulder condition and makes a decision of shoulder parking.

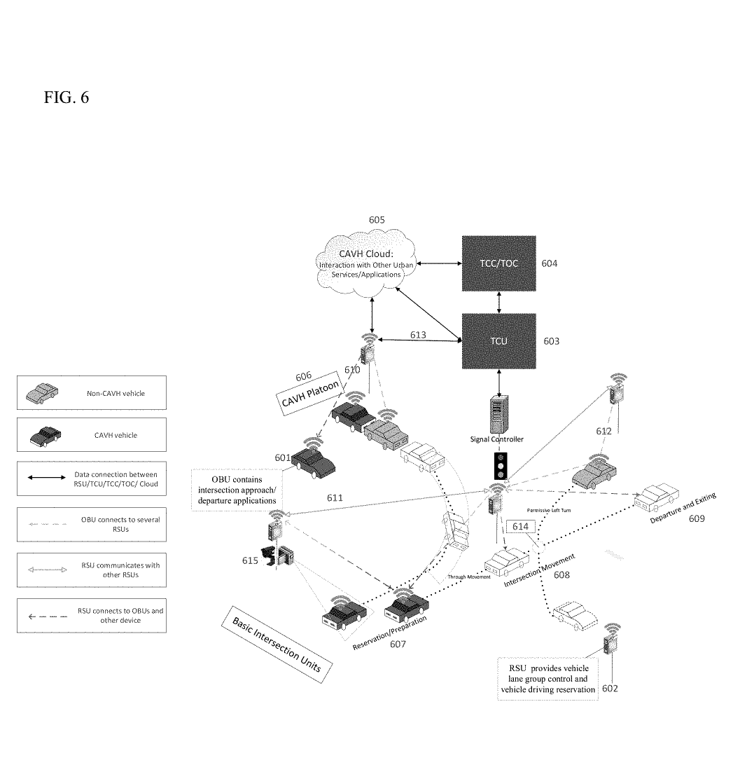

FIG. 6 shows a basic intersection system residing in a CAVH system that contains the following components: OBU 601, RSU 602, TCU 603, TCC/TOC 604, and CAVH cloud 605. The OBU collects data needed for intersection movement such as sensor data and human input and sends them to several RSUs 612. The RSUs store and process the data and then send control/guidance signals, such as intersection entering speed, back to the OBU. The sensors in intersection RSU 615 detects vehicles having different movement. Then the RSU communicates with other RSUs 611 to share information or regulate vehicles. In addition, RSUs communicate with nearest TCU 613 and upload collected and fused data to a TCU for further analysis.

The intersection segment has three CAVH control stages for vehicle movement. The first stage is reservation and preparation 607. At this stage, the CAVH vehicle prepares for entering the intersection and transmits routing and status information to an RSU. The RSU works with the TCU at the intersection to determine appropriate feedback signals such as approaching speed or lane control and signals to CAVH vehicles. The next stage is intersection movement 608, where the RSU and OBU coordinate to determine and execute the optimal intersection passing movement. The last stage is departure and exiting 609, where a vehicle leaves the intersection and the system executes handoff functionalities from intersection nodes to downstream segments or nodes.

Other interactive subsystems at CAVH intersections may be employed. For example, in some embodiments, the system provides coordinated control to CAVH intersection platoon 606 with vehicles inside or outside the system and with similar turning or approaching movement. If a vehicle is outside the system and a CAVH vehicles is in conflict 614, the system computes and optimizes instructions to guide vehicles to leave the intersection.

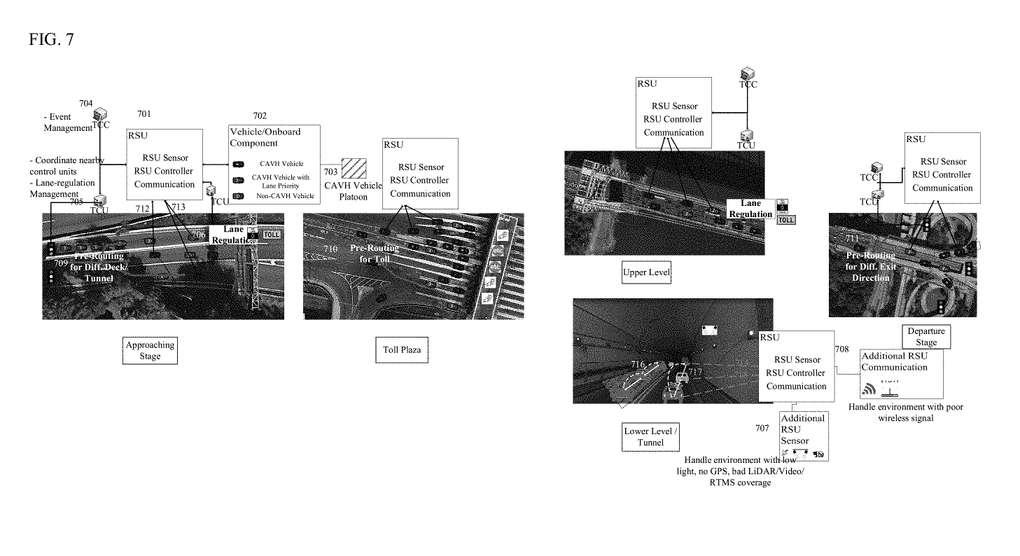

FIG. 7 shows a bridge/tunnel/toll plaza system residing in a CAVH system that contains the following components: RSU 701, CAVH Vehicle/OBU 702, CAVH Vehicle Platoon 703, TCC 704, TCU 705, lane regulation 706, Additional RSU Sensor for Tunnel/Bridge Lower Deck 707, and Additional RSU Communication for Tunnel/Bridge Lower Deck 708. A CAVH vehicle is detected by and can communicate with RSU 1101 to send feedback and receive control command via V2I link 712. Non-CAVH vehicles can also be detected by the RSU via non-CAVH V2I Link 713, but cannot communicate with the RSU. However, the detection and communication may be limited via V2I link 714/715 in an in-door environment, e.g., tunnel and lower level of a bridge. Thus, additional RSU sensor 1107 and communication devices 708 are employed. Full CAVH V2V link 716 and partial CAVH V2V link 717 provide the supplementary detection/communication link to expand the system coverage, especially in an in-door environment. An RSU also connects with TCC 704 and TCU 705 for event signal management, nearby control unit coordination, and lane management based on additional lane regulation. In approaching stage, toll plaza, and departure stage, pre-routing services 709/710/711 are provided via V2I links.

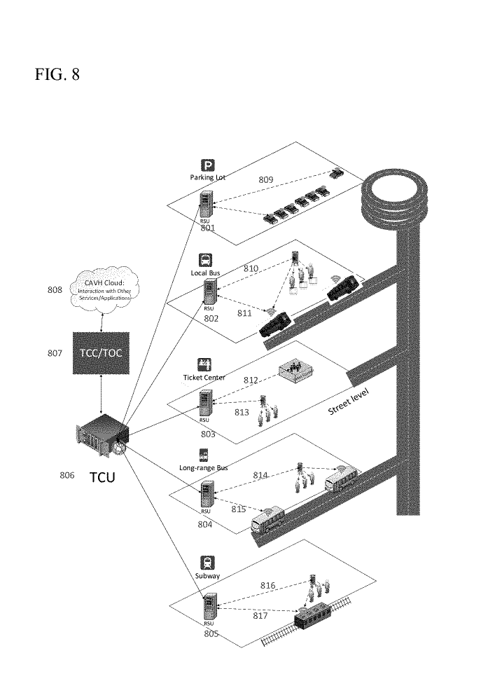

FIG. 8 shows a multi-terminal segment residing in a CAVH system that contains the following layers: Parking lot, local bus, ticket center, long-range bus, and subway. For the parking lot layer, parking lot RSU 801, that has parking sensing and auto parking guidance, communicates with CAV/OBUs 809 to transfer instructions and sensor data. For the Local bus layer, the RSU 802 provides a within-terminal facility traffic sensing system, transit schedule, and planning. The RSU sends the transit schedule to hand held units (HHU) 810 and instruction or sensor data to bus OBUs 811. For a long-range bus, the RSU 804 has similar functions of local bus RSU, but has waiting time arrangement and baggage allocation functions. The RSU communicates with HHUs and OBUs 814. The ticket center RSU 803 has a user interface with HHUs 813 for ticketing which helps ticket center server 812 provide ticketing information and a ticket reservation transit schedule. For subways, RSU 805 provides a platform for HHUs 816 and subway system 817.

1-93. (canceled)

94. A connected and automated vehicle highway (CAVH) system for managing a transportation system, the CAVH system comprising a basic segment system comprising:
a) a vehicle and onboard subsystem configured to control and coordinate vehicles in the CAVH system;
b) a roadside sensing and command subsystem configured to sense the environment and control and/or coordinate vehicles in the CAVH system;
c) a local and regional traffic control unit (TCU)/traffic control center (TCC) subsystem (TCU/TCC) configured to optimize movement of vehicles in the CAVH system;
d) a cloud and CAVH service provision subsystem configured to provide mobility services, data services, application services, and interface services;
e) an analytic, optimization, computing, and security center subsystem comprising hardware and equipment for providing CAVH services; and/or
f) a basic segment subsystem and infrastructure configured to provide high-definition maps, provide high-definition positioning, support other subsystems, and manage movement of vehicles among CAVH segments.

95. The CAVH system of claim 94 wherein said vehicle and onboard subsystem comprises:
a) an interface module configured to communicate between a vehicle and a human user;
b) a communication module configured to transmit and receive vehicle control signals and traffic data to and from a roadside unit (RSU);
c) a sensing module configured to collect surrounding information using sensors installed on vehicles and use said information for making driving decisions and send information to an RSU using the communication module;
d) an identification and security module configured to provide vehicle-unique information to the CAVH system for tracking and security purposes;
e) a bilevel driving signal combination module configured to combine information from an RSU and from a vehicle sensing module and divide the information into a high-level signal group and a low-level signal group; and
f) an operation module configured to make decisions about vehicle routing and operate the CAVH system based on a fused driving signal from other modules.

96. The CAVH system of claim 94 wherein said roadside sensing and command subsystem comprises:
a) a sensing component configured to collect environmental information;
b) a communication component configured to transmit and receive vehicle control signals and traffic data to and from a vehicle and exchange information with an upstream TCU; and/or
c) a control and coordination component configured to manage transmission of TCU control and coordination commands for RSUs and communicate the commands to a vehicle subsystem.

97. The CAVH system of claim 94 wherein said local and regional TCU/TCC component is configured to optimize and control vehicles in a CAVH system at a low level, mid level, and/or high level, wherein:
a) low-level (T2V) optimization and control comprises driving queue management, entering/exiting, and transition;
b) mid-level optimization and control comprises load balancing and event alerts; and/or
c) high-level (TMC) optimization and control comprises congestion detection, alert, and mitigation.

98. The CAVH system of claim 94 comprising a bottleneck segment subsystem comprising:
a) a vehicle and onboard component configured to operate a CAVH vehicle in congested driving mode instead of regular mode to reduce fuel consumption and increase safety and driver comfort using eco-driving and/or platooning algorithms;
b) a roadside component configured to evaluate traffic in a bottleneck segment and organize CAVH vehicles to reduce shockwaves and stop-and-go waves in macroscopic and/or mesoscopic levels by speed harmonization and dynamic merge control;
c) a TCC component configured to process regional traffic control signals including detouring, temporary lane regulation, and/or interaction with other segment subsystems;
d) a cloud component configured to use personal data management including destination change, detouring demand, appointment reschedule, emergency, and/or toll collection plan;
e) a sensing component configured to provide overlapping sensing for vehicles in crowded traffic to supplement and/or replace line of sight sensing for traffic sensors; and/or
f) a communication component configured to provide supplemental communication capacity to minimize and/or eliminate signal loss and lag,
wherein said bottleneck segment subsystem manages traffic congestion comprising relatively low speed and high density vehicles to facilitate low speed car following, driver comfort, and/or energy efficiency.

99. The CAVH system of claim 94 comprising a merge, diverge, and weaving segment subsystem comprising:
a) a vehicle control component configured to identify vehicles, target vehicles to lanes and/or links, detect and transmit vehicle trajectory, deliver merge control signals, and/or provide a human-machine interface;
b) an RSU control component configured to provide a dynamic map of merging and participating vehicles, manage vehicle data, optimize gap and lane changing, manage communication of vehicle data feedback, and generate vehicle-based control guidance signals; and
c) a TCC control component configured to provide macroscopic merge control commands in response to macroscopic traffic conditions,
wherein said merge, diverge, and weaving segment subsystem is configured to manage mainline thru-vehicles, on-ramp merging vehicles, and mainline diverging vehicles on mainline links, on-ramps, and off-ramps by providing customized control or guidance signals to vehicles equipped with or without CAV technologies.

100. The CAVH system of claim 94 comprising a first and last mile subsystem that comprises:
a) an access subsystem configured to manage vehicle access to the CAVH system; and/or
b) an egress subsystem configured to manage vehicle egress from the CAVH system,
wherein said first and last mile subsystem is configured to manage trip start, trip end, vehicle access, vehicle egress, driving navigation, human-machine interaction, and transition alerting and parking

101. The CAVH system of claim 100, wherein said access subsystem:
a) is configured to collect vehicle identification and origin-destination information from vehicles entering the CAVH system and transfer the information throughout the CAVH system;
b) configures OBUs of vehicles entering the CAVH system to provide human-machine interaction, provide alerts to drivers that CAVH access has begun, provide first mile navigation, and provide transfer-compliant driving;
c) configures an RSU to identify accessing vehicles, collect access requests and/or access information, and/or charge a parking fee;
d) configures a TCU and/or TCC to obtain data from an RSU and manages vehicle approaching, routing, and movement; and/or
e) configures a cloud component to manage multi-modal transportation and transfers, manage travel schedules, and manage user meetings and traveling.

102. The CAVH system of claim 100, wherein said egress subsystem is configured to:
a) alert drivers of vehicles exiting said CAVH system to select destination parking lots;
b) return control of vehicles to drivers or park vehicles at a storage or buffer location; and/or
c) park vehicles in an exit node that is an automated parking location.

103. The CAVH system of claim 100, wherein said egress subsystem:
a) configures OBUs of vehicles exiting the CAVH system to provide human-machine interaction, provide alerts to drivers that CAVH exiting has begun, provide automated parking, and provide transfer-compliant driving;
b) configures an RSU to identify exiting vehicles, collects exit requests and/or exiting information, and/or provides parking sensing information including availability and restrictions;
c) configures a TCU and/or TCC to obtain data from an RSU and manages vehicle approaching, routing, and movement; and
d) configures a cloud component to provide point-of-interest (POI) recommendations and parking information to a driver.

104. The CAVH system of claim 94 comprising a buffer subsystem configured to:
a) select a buffer parking lot near the vehicle destination at the CAVH boundary;
b) select a temporary parking lot when a buffer parking lot is not available near the vehicle destination;
c) plan a buffer loop and control the vehicle on a CAVH road; and/or
d) park a vehicle on a road shoulder and/or manage vehicle control, wherein said buffer subsystem is configured to manage vehicle control and/or parking of vehicles that approach an exit point of the CAVH system when drivers of said vehicles do not assume control or respond to alerts that the vehicle is approaching the CAVH system exit.

105. The CAVH system of claim 94 comprising an intersection subsystem comprising:
a) an intersection node configured to manage vehicle spacing and provide a reservation system to manage vehicles at an intersection;
b) a controller to integrate intersection information and provide information to the CAVH system;
c) an intersection service configured to manage vehicle grouping, lane and route assignment, pedestrians, and bicycles; and/or
d) a computing and management center configured to provide signal timing plans, lane and route management, and tracking and predicting CAVH and non-CAVH vehicle movements and interactions,
wherein said intersection subsystem:
e) configures OBUs of vehicles to provide dynamic control of vehicles and manage intersection approach and departure for vehicles in an intersection segment;
f) configures RSUs to provide vehicle lane control, vehicle reservation system, and to plan movement of vehicles through an intersection segment; and/or
g) configures TCU/TCCs for intersection segments to manage vehicle approach, control intersection RSUs, and manage vehicle movements.

106. The CAVH system of claim 94 comprising a bridge, tunnel, and toll plaza subsystem comprising:
a) a vehicle level component configured to provide pre-merging control signals to prepare vehicles that approach a bridge, tunnel, or toll plaza;
b) an RSU level component configured to provide a real-time map of vehicles and to generate and distribute pre-merging plans;
c) a TCU level component configured to communicate with control units to adjust traffic light signals and other control objectives to coordinate entrance and exit of traffic and achieve a system-wide optimization; and
d) a TCC level component configured to receive event signals for heavy congestion, incidents, maintenance, and extreme weather and assist controlling the subsystem,
wherein said bridge, tunnel, and toll plaza subsystem is configured to manage route planning, pre-merging control, and special lane navigation and control for vehicles.

107. The CAVH system of claim 106 wherein said bridge, tunnel, and toll plaza subsystem is configured to:
a) plan routes for vehicles using vehicle trajectory and/or destination information that is thru-traffic, entering off-ramp, and/or entering dedicated lane; and/or vehicle type that is high-occupancy vehicle, priority vehicle, vehicle needing weighing, and vehicle with e-toll tag;
b) route vehicles to special lanes using information comprising vehicle eligibility for special lanes, vehicle identifying information, occupancy levels for a HOV lane, electronic toll tag availability for a HOT lane, and/or routing plans for a reversible lane;
c) manage vehicle platoons to facilitate cooperative car following and vehicle platoon formation;
d) configure RSUs to manage vehicle platoon formation, deformation, and vehicle insertion and leaving events; and/or
e) configure TCC/TCUs to process event information signals to provide warnings and guidance signals.

108. The CAVH system of claim 94 comprising a parking subsystem comprising:
a) a before trip subsystem comprising a human-machine interface that allows drivers to make driving requests and selects trip origin and destination;
b) a during-trip subsystem configured to send an alert from an RSU to a human-machine interface onboard a vehicle to select destination parking plans when vehicles approach a destination; and
c) an after trip subsystem configured to execute parking charging and control vehicle restarting and rerouting,
wherein said parking subsystem is configured to manage CAV parking and maximize safety and efficiency of vehicle access to and egress from the CAVH system.

109. The CAVH system of claim 108 wherein said parking subsystem is configured to:
a) configure TCUs and TCCs to process requests and transmit commands to parking lot RSUs to manage parking lot exit control and provide travel route guidance to a vehicle;
b) transfer vehicle control to a first and last mile subsystem when a parking destination is outside the CAVH system;
c) terminate vehicle control when a vehicle is parked at selected parking lots within the CAVH system; and/or
d) park vehicles at a storage or buffer location if a driver is not available to make a parking decision.

110. The CAVH system of claim 94 comprising:
a) a multi-modal terminal component configured to provide I2X and V2X integration with other segments and nodes;
b) a multi-modal terminal segment configured to provide park and ride options, pickup and drop-off locations, and gate and waiting areas;
c) a vehicle and onboard system configured to provide navigation and self-driving within a terminal; guided and automated parking; multimodal notification, schedule selection, and schedule adherence; and navigation away from a multi-modal terminal segment to initiate a next trip;
d) an RSU configured to provide a within-terminal facility traffic sensing system, parking sensing, and auto parking guidance;
e) TCUs/TCCs configured to provide local and regional traffic control, manage intersections, manage vehicle approach to a terminal, manage vehicle departure from a terminal, provide in-terminal RSU control, and provide integrated corridor management (ICM) service;
f) a cloud component configured to provide multi-model planning, mode transferring and ticketing, parking space reservation, and a fare payment system;
g) a multi-modal services component configured to manage multi-modal trips, parking planning, and operations; and/or
h) a management center configured to manage multi-modal optimization and computing, inter-system coordination, pickup and drop-off optimization, and vehicle relocation optimization.

111. The CAVH system of claim 94 comprising connected segments and nodes, wherein:
a) each CAVH segment and node comprises a road-side unit (RSU) configured to provide sensing functions, communication functions, and vehicle control functions for the CAVH segments and nodes;
b) neighboring segments and nodes have overlapping sensing and control areas and pass control of controlled and automated vehicles (CAV) from segments and nodes to neighboring segments and nodes;
c) CAVs comprise an onboard unit (OBU) configured to communicate with RSUs, send and receive sensor data with RSUs, and receive vehicle-specific control instructions from RSUs;
d) multiple RSUs are managed by a traffic control unit (TCU) configured to provide a dynamic map of objects in the CAVH system and coordinate control of CAVs by the RSUs; and
e) multiple TCUs are managed by a traffic control center (TCC) configured to manage traffic in the CAVH system.

112. The CAVH system of claim 111 wherein:
a) RSUs comprise LiDAR, computer vision sensors, and/or radar sensors to provide sensor data for segments and nodes; and
b) RSUs manage collision avoidance, routing, lane changing, and provide vehicle-specific control instructions to CAVs.

113. The CAVH system of claim 111 wherein the TCCs:
a) provide a dynamic map of traffic congestion, incidents, inclement weather, and/or events with regional impact; and/or
b) manage interaction of the CAVH system with payment and transaction systems, regional traffic management centers (TMCs), and third-party applications.

114. The CAVH system of claim 94 comprising:
a) vehicle-level data flow comprising:
1) RSU security certificate and RSU identification information that identifies an RSU controlling an OBU;
2) vehicle-based sensor data describing surrounding vehicles and road conditions;
3) on-road guidance coordinates and other signals or notifications sent by an RSU to an OBU; and
4) control signals sent from an OBU to a vehicle mechanical system, said control signals comprising gas pedal actuator levels, brake actuator levels, and/or turning angles; and/or
b) RSU-level data flow comprising:
1) vehicle identification data and routing plans, wherein an RSU receives vehicle identification data and routing plans and coordinates signals from a TCU;
2) sensor data of moving objects and infrastructure states within the RSU coverage area, said sensor data of moving objects and infrastructure states comprising speed limit, traffic control device states, vehicle conflict information, weather, and/or road surface conditions; wherein said sensor data of moving objects and infrastructure states is transmitted to vehicles; and wherein sensor data is transmitted through wired or wireless connection to a TCU to assist CAVH system management of a local or regional network;
3) guidance instructions transmitted by RSUs to vehicles by wireless communication; and
4) vehicle handoff data comprising vehicle identification, routing, and on-road guidance coordinate data communicated by RSUs to neighboring RSUs.

115. The CAVH system of claim 94 comprising:
a) a TCU-level data flow comprising:
1) vehicle identification, routing plans, regional incidents, and event alert data;
2) vehicle-specific coordination signals transmitted to RSUs to coordinate vehicle pre-routing for mandatory lane changes, compliance with mandatory lane regulations; and/or pre-merging due to congestion;
3) RSU sensing data to assist CAVH system management of CAVH roadway segments and nodes; and/or
4) vehicle handoff data comprising vehicle identification, routing, and on-road guidance coordinate data communication by TCUs to neighboring TCUs; and/or
b) a TCC-level data flow comprising:
1) data exchanged with transaction, payment, transit, and third party applications;
2) congestion mitigation information and active traffic management signals sent to individual TCUs;
3) data exchanged with regional traffic management centers describing congestion, incidents, construction, special events, and traffic management information; and
4) CAVH vehicle identification and origin-destination and routing plans for CAVH vehicles.

116. The CAVH system of claim 94 configured to manage entry and egress of vehicles into and out of said transportation system.

117. The CAVH system of claim 94 comprising entry nodes that are parking lots, side streets, ramps, and/or intersections.

118. The CAVH system of claim 94 configured to:
a) collect and communicate vehicle identification and/or origin-destination information for vehicles entering the CAVH system; and/or
b) return control of vehicles to drivers for vehicles exiting the CAVH system.
